(19) United States
(12) Patent Application Publication
(10) Pub. No.: US 2008/0118244 A1
(43) Pub. Date: May 22, 2008

(54) Resilient packet ring (RPR) network system, RPR node device, redundancy method for the same, program and computer-readable medium

(75) Inventor: Tatsuhiro Nakada, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/984,044

(22) Filed: Nov. 13, 2007

(30) Foreign Application Priority Data
Nov. 21, 2006 (JP) 314792/2006

(51) Int. Cl. H04B 10/20; H04J 14/00

(52) U.S. Cl. 398/59

(57) ABSTRACT

An RPR network system provides redundancy to the RPR function, at occurrence of failure in an RPR node device, to communicate with RPR node devices other than the failed device on an RPR ring and redundancy to an ethernet (registered trademark) port function to communicate a MAC frame via ports. The system includes a plurality of node devices connected on a link to each other in which two adjacent RPR node devices, i.e., first and second node devices, cooperatively operate as one virtual RPR node device. The first node device is set as a master device to communicate as the virtual RPR node device with other RPR node devices and the second node device is set as a slave device not to communicate as the virtual RPR node device with other RPR node devices, the master and slave devices being replaceable by each other. Either one of ports belonging respectively to the master and slave devices is capable of outputting data therefrom.

This application is based on upon and claims the benefit of priority from Japanese patent application No. 2006-314792, filed on Nov. 21, 2006, the disclosure of which is incorporated herein in its entirety by reference.

### BACKGROUND OF THE INVENTION

1. Field of the Invention

The present invention relates to an RPR network system, an RPR node device, a redundancy method for the same, a program, and a recording medium, and in particular, to a technique appropriately applicable to a resilient packet ring which is drawing attention as a backbone of a Metro Area Network (MAN).

2. Description of Related Art

In the recent communication fields, with appearance and prevalence of broadband techniques such as an Asymmetric Digital Subscriber Line (ADSL) and Fiber To The Home (FTTH), traffic on internet connection lines is remarkably increasing. For the communication network as the backbone of the network in Japan (for example, the network between Tokyo and Osaka), management for an increase in communication capacity has succeeded by use of such as Wavelength Division Multiplexing (WDM). For the user-side access line called “last one mile”, the increase in communication capacity is being encouraged through wide use of such as ADSL in which existing telephone lines are adopted without any modification.

In contrast with successful prospects for the large capacity of the backbone line and the user-side access line, the intermediate area has not been fully prepared for the increased traffic. It has been recognized that the intermediate area is possibly a bottleneck in the communication. Particularly, in the urban areas where the broadband service has started earlier and a great demand for the service is expected due to many active users in such areas, the intermediate network, i.e., “middle mile” is relatively important. The Metro Area Network (MAN) is a network to enhance the increase in the communication capacity of “middle mile”. The MAN is a new network mode to cover approximately an urban area size and is ranked almost between the Local Area Network (LAN) and the Wide Area Network (WAN).

The MAN has three conspicuous aspects. First, it is possible to construct a low-cost network such as a layer 3 switch to provide inexpensive services. Second, there can be prepared a high-speed, large-capacity menu ranging from about one Megabits per second (Mbps) to about one Gigabits per second (Gbps) using the ethernet (registered trademark) interface. Third, such as changing a contracted or adding a new communication line can be performed on the web. However, the MAN is accompanied by disadvantages as follows; a reliability declines due to a installation of a long network ring; at occurrence of failure on a node installed at a remote location, restoration of the failure takes a tremendously long period of time; and although Synchronous Optical Network (SONET)/Synchronous Digital Hierarchy (SDH) mainly employed as the backbone is superior in resistivity against failure, reliability and expandability of the system, transmission path efficiency is not satisfactory and the system is expensive.

The Resilient Packet Ring (RPR) has been developed as a technique to solve the above problems of MAN. As implied by “resilient”, the RPR is a transmission technique which emphasizes a failure restoring function and is standardized according to Institute of Electrical and Electronics Engineers (IEEE) 802.17.

The RPR configuration includes a ring-type network in which a plurality of nodes are connected via a bidirectional duplicated ring line supporting communication in mutually opposing transmission directions. In the RPR system, each RPR nodes on the bidirectional duplicated ring line has a function to broadcast its physical address onto the ring as well as a function to collect broadcast information to recognize a topology map indicating a sequential order of each node. Each node also has a function to select a ring in the vicinity of a physical address as a destination referring the topology map to send the packet onto the ring. The node has a failure restoring function to restore the network failure in which the node detect a position of failure on the ring quickly, switch paths, and detour the failure position by monitoring information of failure periodically transmitted from each node. It is aimed to restore the failure in 50 milliseconds (ms) or less almost equal to the failure restoration time of SONET/SDH.

According to SONET/SDH, one of the rings is employed exclusively to recover failure, since only 50% of the bandwidth is available. However, in accordance with RPR, data items can propagate on the two rings at the same time to fully use the bandwidth. This makes it possible to efficiently use the bandwidth through reuse of space. Data communications on RPR adopt three kinds of RPR frames, i.e., a data frame to transfer data, a control frame for maintenance and management of rings, and a fairness frame to manage fairness of the bandwidth. It is therefore possible to secure the bandwidth fairness on the basis of a fairness algorithm.

For example, Japanese Patent Application Laid-Open Ser. No. 2002-359628 describes a redundancy technique to cope with occurrence of failure on a network. According to the technique proposing a protection method, the bandwidth of the ring network system is efficiently utilized if the network is normally operating without failure. At occurrence of failure, the system executes protection processing to send each data item to a destination thereof. Specifically, if failure is present, the system conducts a link aggregation to gather a working channel and a protection channel. Otherwise, data are transmitted by detouring the location of failure in the absence of failure.

Japanese Patent Application Laid-Open Ser. No. 2005-184666 has been devised to solve the problem in which it is not possible to employ a redundancy method for failure in a node or the like caused by packet communication utilizing only an actual physical address. Specifically, there is proposed a ring network configuration in which a plurality of nodes shares a virtual physical address to conduct operation complementally. Japanese Patent Laid-Open Application Ser. No. 2006-129071 describes a technique for use with node devices constituting a ring network linked via a redundant node device with another network. A plurality of redundant node devices simultaneously could operate as active devices. It is also possible to perform load distribution processing for packet processing of redundant node devices in accordance with an increase and a decrease in the number of active redundant node devices involves in the occurrence/restoration of a failure of a redundant node device. Moreover, it is possible to use a node redundancy method applicable to RPR.

According to RPR associated with the present invention, when an RPR node device fails, the protection procedure of the failure restoring function is accomplished as described above, so that the failure location is detoured and hence the communication is possible for the nodes other than the failed node. However, ports belonging to the failed node are disconnected from the RPR ring and hence cannot conduct any communication.

FIG. 1 shows a state of protection at occurrence of failure according to RPR in a related art. If failure takes place in, for example, an RPR station 210, RPR stations 220 and 240 adjacent thereto carry out the protection by use of steering or wrapping prescribed by IEEE 802.17. The lines of the stations other than the failed station 210 are protected, however, the tributary port of the failed station 210 is separated from the RPR ring and hence cannot conduct communication of a Media Access Control (MAC) frame.

Therefore, there has been desired a technique to cope with the occurrence of failure in a node device to provide redundancy to the RPR function to communicate with RPR node devices other than the failed device on the ring and redundancy to an ethernet (registered trademark) port function to communicate a MAC frame via ports. Neither one of the above articles describes a technique to provide redundancy to the RPR function and redundancy to the ethernet (registered trademark) port function with the occurrence of failure in a node device.

### SUMMARY OF THE INVENTION

An exemplary object of the present invention is to provide an RPR network system, an RPR node device, a redundancy method for the same, a program, and a recording medium capable of providing redundancy to the RPR function, at occurrence of failure in an RPR node device, redundancy to the RPR function to communicate with RPR node devices other than the failed device on the ring and redundancy to an ethernet (registered trademark) port function to communicate a MAC frame via ports, simultaneously.

To achieve the object, the present invention has aspects as follows.

### RPR Network System

A RPR network system according to an exemplary aspect of the invention includes a plurality of node devices connected on a link to each other in which two adjacent RPR node devices selected from the plural node devices cooperatively operate to configure one virtual RPR node device. The two adjacent RPR node devices are set such that a first one thereof is a master device for communicating as the virtual RPR node device with a particular one of the RPR node devices and a second one thereof is a slave device not communicating as the virtual RPR node device with the particular RPR node device, the master and slave devices being replaceable by each other. Either one of ports belonging to the master and slave devices is capable of outputting data therefrom.

### RPR Node Device

A RPR node device for use with the RPR network system according to an exemplary aspect of the invention includes a plurality of node devices connected on a link to each other in which two adjacent RPR node devices selected from the plural node devices cooperatively operate to configure one virtual RPR node device. The two adjacent RPR node devices are set such that a first one thereof is a master device for communicating as a representative of the virtual RPR node device with a particular one of the RPR node devices and a second one thereof is a slave device not communicating as the representative of the virtual RPR node device with the particular RPR node device, the master and slave modules being replaceable by each other. Each of the two adjacent RPR node devices includes a control unit, an RPR function unit, and an L2 function unit. The control units of the two node RPR devices mutually notify states of failure in the respective node devices, MAC addresses of the respective node devices, and states of ports respectively belonging to the respective node devices to each other to thereby share the information items regarding the virtual RPR node device, and change over the setting of the master device on the basis of the states of failure shared therebetween. The RPR function units control a communication function on an RPR layer, transmit data from the master device to the particular RPR node device designating the MAC address of the master device as a source address, and receive by the master device from the particular RPR node device data designating the MAC address as a destination address. The L2 function units select one of the ports which are under control of the virtual RPR node device and which belong respectively to the master and slave devices to assign the port as a destination port.

Also, a RPR node device for use with a RPR network system according to an exemplary aspect of the invention includes a plurality of node devices connected on a link to each other in which two adjacent RPR node devices selected from the plural node devices cooperatively operate to configure one virtual RPR node device. The two adjacent RPR node devices are set such that a first one thereof is a master module for communicating as a representative of the virtual RPR node device with a particular one of the RPR node devices and a second one thereof is a slave module not communicating as the representative of the virtual RPR node device with the particular RPR node device, the master and slave modules being replaceable by each other. Each of the two adjacent RPR node devices respectively includes an information sharing unit, a master device switching unit, a RPR function control unit, and a port assigning unit. The information sharing units mutually notify states of failure in the respective node devices, MAC addresses of the respective node devices, and states of ports respectively belonging to the respective node devices to each other to thereby share the information items regarding the virtual RPR node device. The master device switching units change over the setting of the master device on the basis of the states of failure therebetween. The RPR function control units control a communication function on an RPR layer, transmit data from the master device to the particular RPR node device designating the MAC address of the master device as a source address, and receive by the master device from the particular RPR node device data designating the MAC address as a destination address. The port assigning units select one of the ports which are under control of the virtual RPR node device and which belong respectively to the master and slave devices to assign the port as a destination port.

### Redundancy Method for RPR Node Device

A redundancy method for an RPR node device for use with a RPR network system according to an exemplary aspect of the invention includes a plurality of node devices connected on a link to each other in which two adjacent RPR node devices selected from the plural node devices cooperatively operate to configure one virtual RPR node device, the RPR node device being used for the two adjacent RPR node devices. The two adjacent RPR node devices are set such that a first one thereof is a master device for communicating as a representative of the virtual RPR node device with a particular one of the RPR node devices and a second one thereof is a slave device not communicating as the representative of the virtual RPR node device with the particular RPR node device, the master and slave devices being replaceable by each other. Each of the two adjacent RPR node devices includes a control unit, an RPR function unit, and an L2 function unit. The method includes the steps of mutually notifying, by the control units of the two node RPR devices, states of failure in the respective node devices, MAC addresses of the respective node devices, and states of ports respectively belonging to the respective node devices to each other to thereby share the information items regarding the virtual RPR node device, and change over the setting of the master device on the basis of the states of failure shared therebetween, controlling by the RPR function sections a communication function on an RPR layer, transmitting data from the master device to the particular RPR node device designating the MAC address of the master device as a source address, and receiving by the master device from the particular RPR node device data designating the MAC address as a destination address; and selecting by the L2 function units one of the ports which are under control of the virtual RPR node device and which belong respectively to the master and slave devices to assign the port as a destination port.

### Program

A program according to an exemplary aspect of the invention causes the two adjacent node devices to execute the above redundancy method for the RPR node device.

### Recording Medium

A recording medium according to an exemplary aspect of the invention stores therein the program and is readable by a computer.

### BRIEF DESCRIPTION OF THE DRAWINGS

The objects and features of the present invention will become more apparent from the consideration of the following detailed description taken in conjunction with the accompanying drawings in which:

FIG. 1 is a schematic block diagram showing an RPR network system associated with a related art;

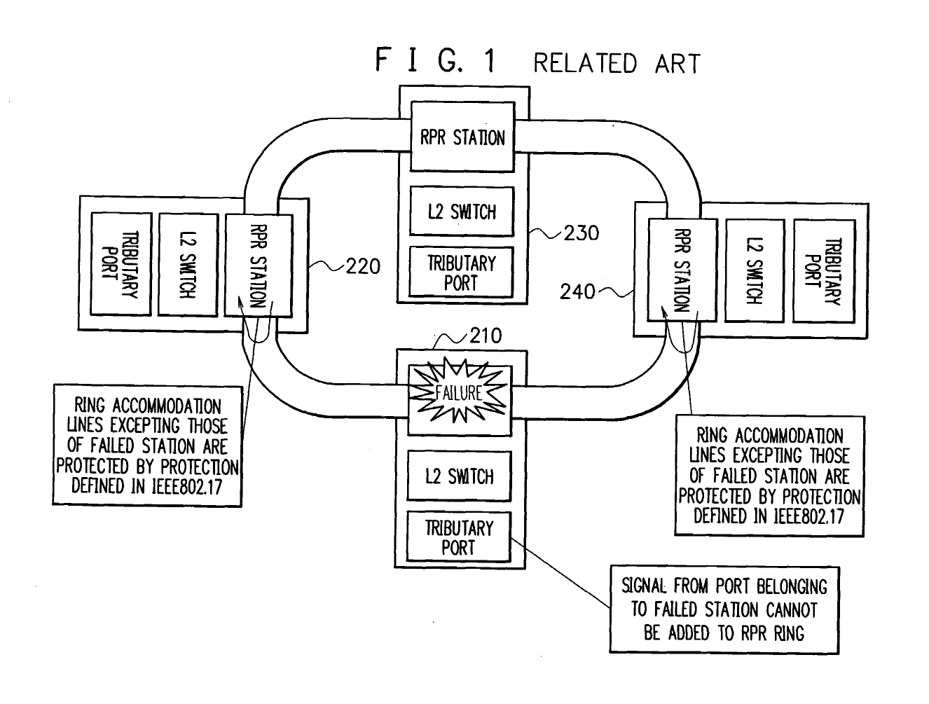

FIG. 2 is a block diagram showing an embodiment of an RPR network system in accordance with the present invention;

FIG. 3 is a flowchart showing a flow of processing after an RPR frame is received;

FIG. 4 is a flowchart showing a flow of processing after a MAC frame is received;

FIG. 5 is a block diagram showing a configuration of an RPR node device;

FIG. 6 is a block diagram to explain an RPR frame receiving operation and a MAC frame output operation;

FIG. 7 is a block diagram to explain an RPR frame receiving operation and a MAC frame output operation;

FIG. 8 is a block diagram to explain an RPR frame receiving operation and a MAC frame output operation;

FIG. 9 is a block diagram to explain an RPR frame receiving operation and a MAC frame output operation;

FIG. 10 is a block diagram to explain a MAC frame receiving operation and an RPR frame transmitting operation;

FIG. 11 is a block diagram to explain a MAC frame receiving operation and an RPR frame transmitting operation;

FIG. 12 is a block diagram to explain a MAC frame receiving operation and an RPR frame transmitting operation;

FIG. 13 is a block diagram to explain a MAC frame receiving operation and an RPR frame transmitting operation; and

FIG. 14 is a diagram schematically showing an embodiment of a configuration of an RPR node device (RPR card) in accordance with the present invention.

### DESCRIPTION OF EXEMPLARY EMBODIMENTS

Referring next to the drawings, description will be given of exemplary embodiments in accordance with the present invention.

### First Exemplary Embodiment

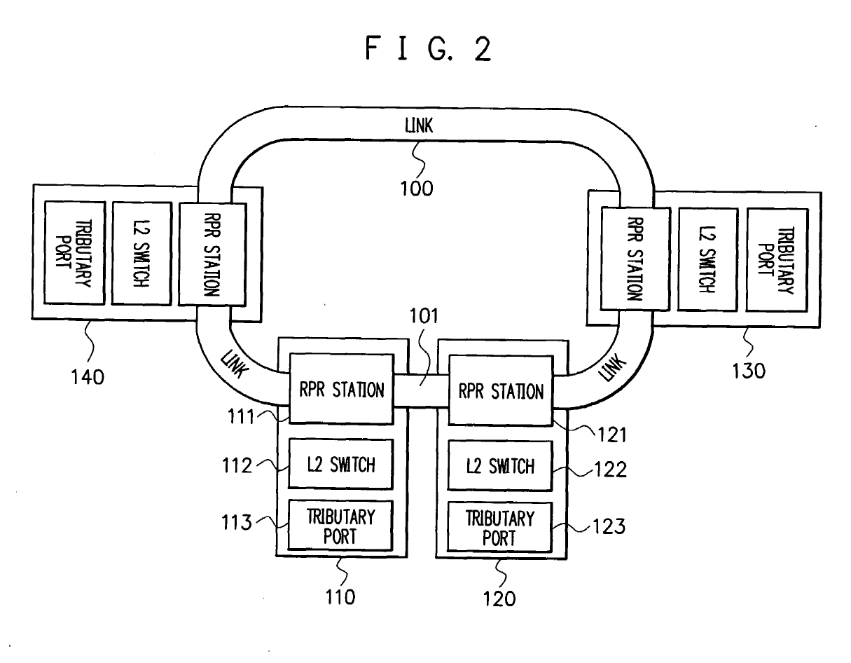

FIG. 2 shows an outline of the configuration of an exemplary embodiment of an RPR network system in accordance with the present invention. The system includes a plurality of RPR node devices 110 to 140 coupled via a link 100 with each other. For example, the RPR node device 110 includes an RPR station 111, an L2 switch 112, and a tributary port 113. This also applies to the other RPR node devices.

The station 111 includes a function to transfer an RPR frame, which is received from the RPR ring and which is addressed to another RPR node device, a function to terminate and to drop an RPR frame addressed to the station 111, and a function in which the station adds an RPR header to a MAC frame received from the tributary port 113 to send the resultant frame as an RPR frame to the RPR ring.

The L2 switch 112 conducts a routing operation for the MAC frame received from the tributary port 113 and the MAC frame that is terminated and dropped by the station 111. The L2 switch 112 is a layer 2 switch. The tributary port 113 is an ethernet port to accommodate a user frame. The link 100 is a transmission path to establish connection between the RPR node devices.

In the RPR network system shown in FIG. 2, the RPR node devices 110 and 120 are adjacent to each other. Each of these devices notifies the state of its tributary port, its RPR address, and a failure state thereof via a link 101 to the communicating device, i.e., the other one device. The link 101 is a transmission route to connect the node devices 110 and 120 to each other. The link 101 has a link capacity that is designed, comparing the other links constituting the RPR ring, to have the transfer rate enough for both of the tributary ports of the devices 110 and 120

Either one of the RPR node devices 110 and 120, which operate in a cooperative manner, is designated as a representative, which is beforehand set to the RPR stations respectively of the RPR node devices 110 and 120. The representative is a module to communicate as a representative of the RPR node devices 110 and 120 with other RPR node devices. It is assumed that the representative device is a master device and the other one is a slave device, and the station of the master device is a master station and that of the slave device is a slave station. In FIG. 2, the RPR node device 110 is a master device and the RPR node device 120 is a slave device.

The master/slave relationship between the two cooperative RPR stations is changed over by a switching operation at detection of occurrence of failure in the master station or when the setting of the relationship is altered. In the switching operation, the RPR node unit as the master station creates, for each entry of a MAC table of the tributary port learned by the L2 switch, an Address Resolution Protocol (ARP) request packet including an RPR address of a new master station as its transmission source, and then broadcasts the packet to the RPR ring. This process resultantly updates a database of the L2 switch in the other RPR node devices on the ring. After the update, communication to the tributary port is carried out for the new RPR station.

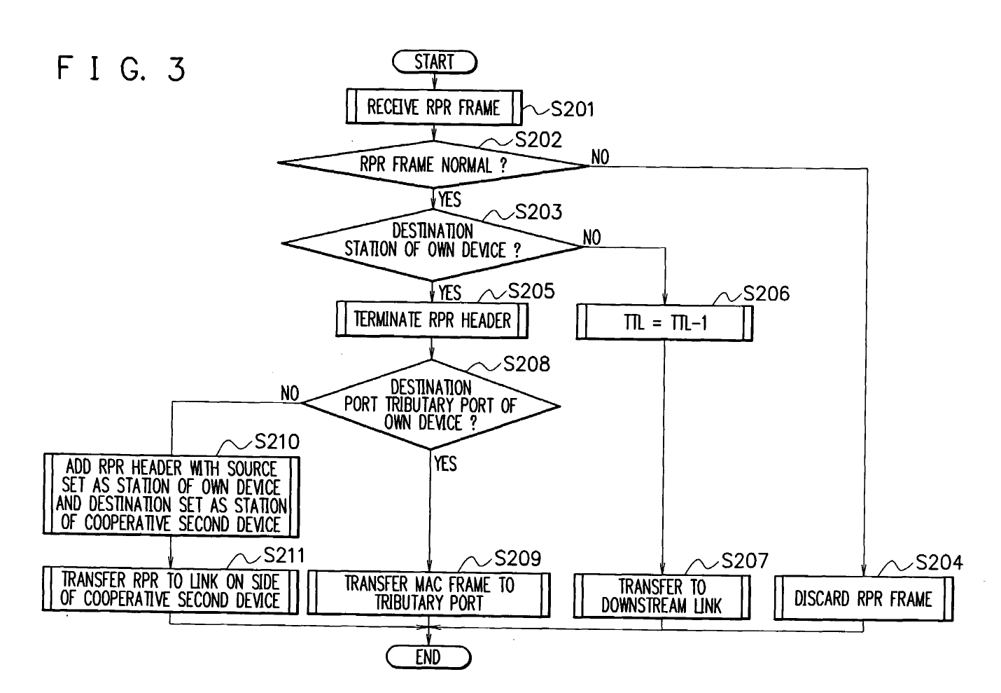

FIG. 3 shows a flow of processing to be executed after reception of an RPR frame by a first RPR node device from another RPR node device in the embodiment of the RPR network system.

First, a first RPR node device, i.e., a master station receives an RPR frame from another RPR node device on an associated link (step S201). The master station checks normality of the frame, including a lifetime of the frame defined in an RPR header (Time To Live (TTL)) (step S202). If the frame is abnormal, the station discards the frame (no in step S202; step S204).

If the received frame is normal (yes in step S202), the RPR station determines whether a destination address of the frame indicates the master station itself or other than the master station (step S203). If the frame is addressed to other than the master station (no in step S203), the master station subtracts one from the value of TTL (TTL update value) and transfers the frame to a downstream link (steps S206 and S207).

If the frame is addressed to the master station (yes in step S203), the RPR station terminates and drops the RPR header in the L2 switch (step S205). The L2 switch conducts tributary port assignment to determine an output port for a Link Aggression Group (LAG) (step S208). The link aggression group is a group employed to efficiently utilize tributary ports respectively of the cooperatively operating two RPR node devices as output destination ports of a virtual RPR node device constructed by the two RPR node devices.

The port assignment may be carried out using various algorithms, for example, a method adopting a transmission source address (SA) of the received MAC frame, a method using a transmission destination address (DA), or a method implemented by combining these methods with each other. Although either method is available, it is required that the two cooperative RPR stations share the method.

As a result of the assignment, if the output destination is a tributary port belonging to the master station (yes in step S208), the RPR node device (the master station) outputs the MAC frame from the tributary port without modification (step 209). If the destination is a tributary port of the other one station, i.e., the slave station (no in step S208), the RPR station adds the RPR header, specifically, sets the transmission source as the master station and the transmission destination as the slave station (step S210) and then transfers the RPR frame to the link on the slave station side (step S211).

The transferred RPR frame is received and terminated by the slave station, and then output from the tributary port thereof according to the flow described above.

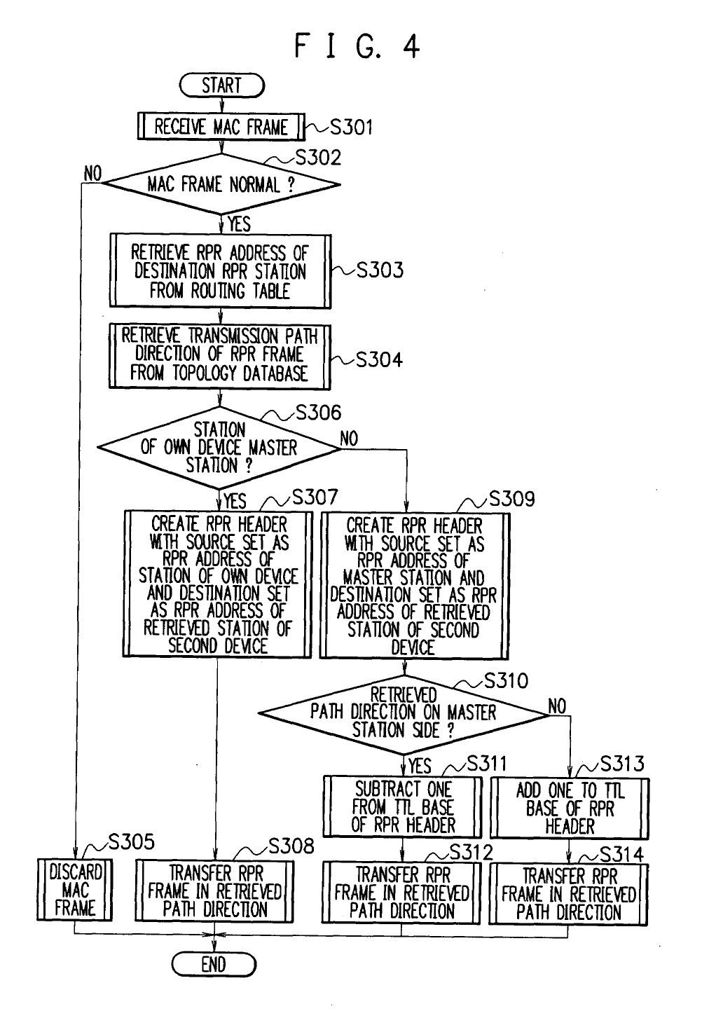

FIG. 4 is a flowchart of processing to be executed after a MAC frame is received from a tributary port in the embodiment of the RPR network system.

The tributary port receives a MAC frame and checks normality of the frame (steps S301 and S302). If the frame is abnormal, the system discards the frame (no in step S302; step S305).

If the MAC frame is normal, (yes in step S302), the L2 switch retrieves the RPR address of the RPR station as the transfer destination from a routing table in the switch (step S303) to determine a path direction for the destination RPR station on the basis of a topology database (step S304).

The RPR station makes determines whether or not the station having received the MAC frame is a master station (step S306). If this is the case (yes in step S306), the RPR station adds the RPR header, namely, sets the transmission source as the RPR address of the master station and the transmission destination as the RPR address of the RPR station retrieved from the routing table to transfer the resultant RPR frame to the link on the path direction determined based on the topology database (step S308).

If the station having received the MAC frame is other than the master station, i.e., the slave station (no in step S306), the RPR station generates and adds an RPR header, specifically, sets the source as the RPR address of the master station and the destination as the RPR address of the RPR station retrieved in advance (step S309).

To correct the lifetime of the RPR frame, the RPR station corrects the TTL base (TTL initial value) of the RPR header according to the path direction for the RPR frame (step S310). If the direction is on the master station side (yes in step S310), the station subtracts one from the value of the TTL base (step S311). Otherwise (no in step S310), the station adds one to the TTL base value (step S313).

The correction is carried out to establish a state in which the output from the slave station seems to have been sent from the master station. As a result, the TTL base of the RPR header shows the same value as that obtained when the output is delivered from the master station. The TTL base is a kind of a value indicating distance, i.e., the number of stations to the RPR station as the destination. Therefore, when the frame is transferred to the path direction on the master station, one is subtracted from the TTL base value to show as if the frame is sent from the station (master station) nearer to the actual transmission source (slave station) by one station. Contrarily, when the frame is transferred to the opposite direction, one is added to the TTL base value to show as if the frame is sent from the station apart from the actual transmission source by one station. In this connection, in other than the TTL base correction, one is subtracted from the TTL value for the update thereof in a situation wherein the frame is sent to an adjacent RPR station and it is determined that the frame is addressed to other than the adjacent RPR station and is hence sent to a next destination.

The corrected RPR header is added to the MAC frame, and the frame is transferred as an RPR frame to the retrieved path direction (steps S312 and S314). Through the above correction, the MAC frame received from the tributary port of the slave station is concealed from the other RPR stations on the RPR ring as if it is transmitted from the master station.

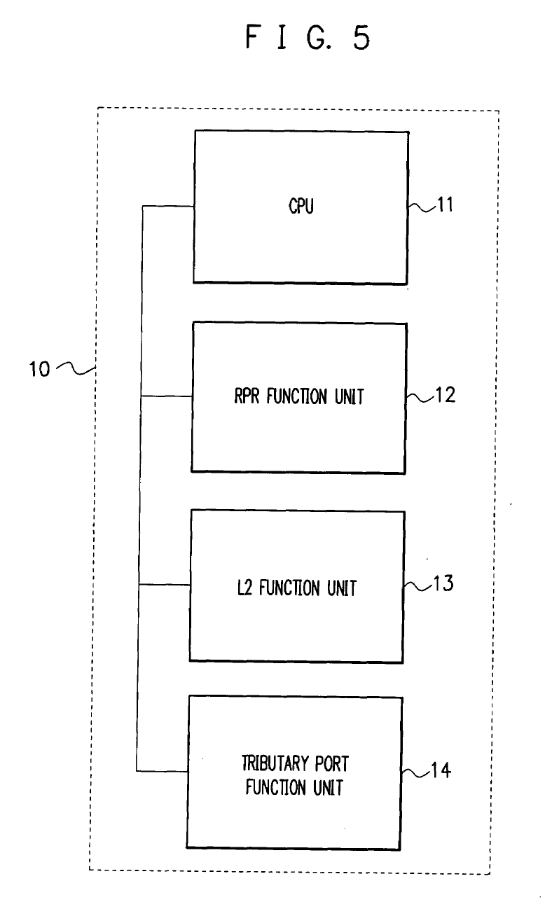

FIG. 5 shows an example of structure of the RPR node device in the embodiment of the RPR network system. An RPR node device 10 includes a Central Processing Unit (CPU) 11, an RPR function unit 12, an L2 function unit 13, and a tributary port function unit 14.

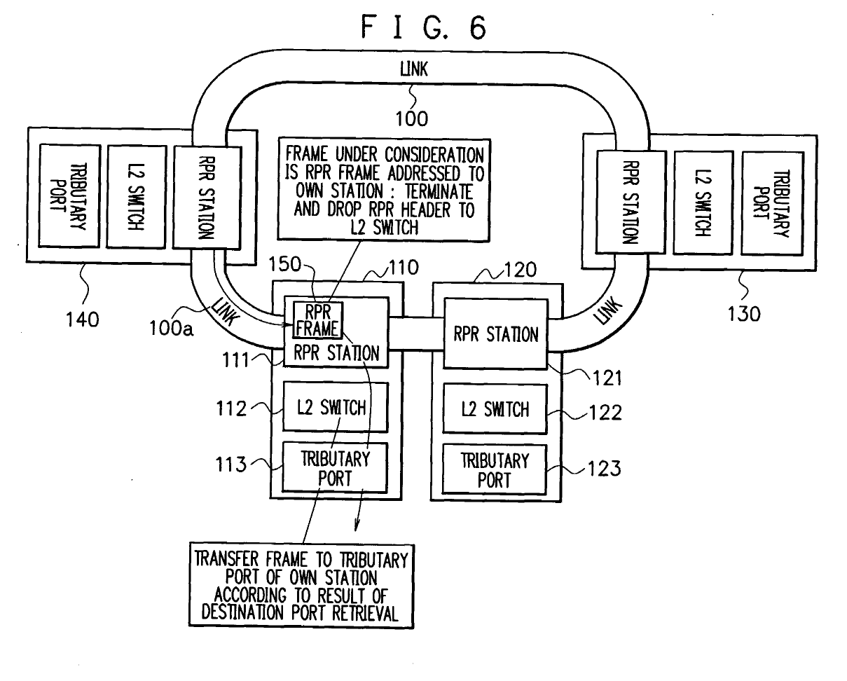

The CPU 11 supervises operation of the node device 10. The RPR function unit 12 processes signals on the RPR layer and executes processing, for example, adds an RPR header to a MAC frame, drops an RPR header from an RPR frame, and transfer the RPR frame. The L2 function unit 13 conducts signal processing on the ethernet layer, namely, carries out a routing operation for a MAC frame which is transferred or received. The tributary port function unit 14 is disposed to execute processing on the physical layer and has a function to interface the user network with the RPR ring. The RPR function unit 12, the L2 function units 13, and the tributary port function unit 14 correspond respectively to the RPR station, the L2 switch, and the tributary port of FIG. 2. This also applies to the configuration diagram of the embodiment of the RPR network system, which will be described later in conjunction with FIG. 6.

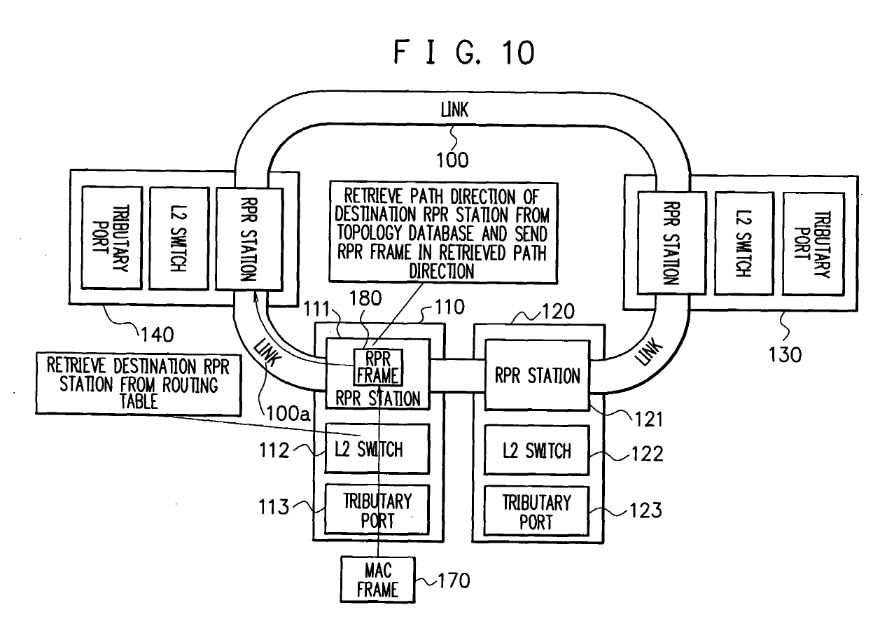

Referring now to FIGS. 6 to 13, description will be given in detail of operations of the master and slave node devices in the embodiment of the RPR network system. FIGS. 6 to 9 are diagrams to explain operation for a first RPR node device to receive an RPR frame from a second RPR node device on the RPR link. FIGS. 10 to 13 are diagrams to explain operation in which a station adds an RPR header to a MAC frame received by an associated tributary port from a user network and transmits the frame as an RPR frame to the RPR link.

FIG. 6 shows operation in which a master device receives an RPR frame from a link on a side opposite to that of an associated slave module and sends as MAC frame from a tributary port thereof.

A RPR frame 150 from a second RPR node device 140 on the RPR link 100 is transferred via a link 100a on the side of the master device 110 to be received by the master station 111. Since the RPR frame 150 is addressed to the master station 111, the master station 111 terminates the received RPR frame and drops the frame as a MAC frame to the L2 switch 112.

The L2 switch 112 calculates a destination tributary port of LAG according to an algorithm and outputs the MAC frame from a tributary port of the station of own device, i.e., the master station 111 obtained as a result of the calculation.

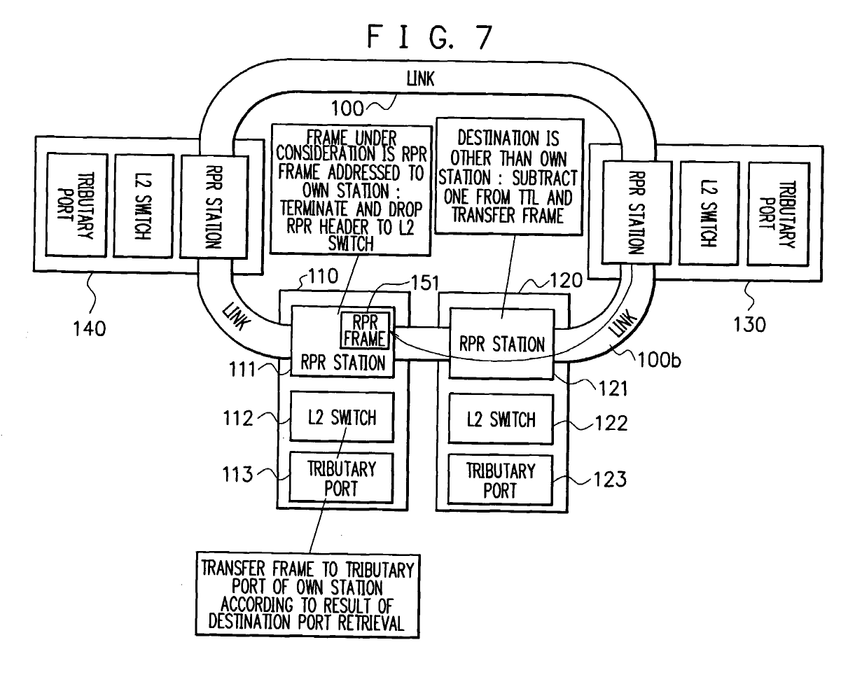

FIG. 7 shows operation in which the master station receives an RPR frame from a link on the slave station side and outputs the frame as a MAC frame from a tributary port of the own device (master device).

The slave station 121 once receives the RPR frame 151 transferred via a link 100b on the slave station side from a second node device 130. The slave station 121 refers to the destination MAC address of the RPR frame to recognize that the destination is other than the station of the own device. Therefore, the slave station 121 subtracts one from the TTL update value and then transfers the frame to a downstream link (toward the master device 110).

The master station 111 refers to the destination MAC address of the receiver RPR frame and recognizes that the frame is addressed to the master station 111. Therefore, the master station 111 terminates the RPR frame 151 and drops the frame as a MAC frame to the L2 switch 112.

The L2 switch 112 conducts a calculation for a destination tributary port of LAG according to an algorithm and then outputs the MAC frame from the tributary port of the station of the own node device determined as a result of the calculation.

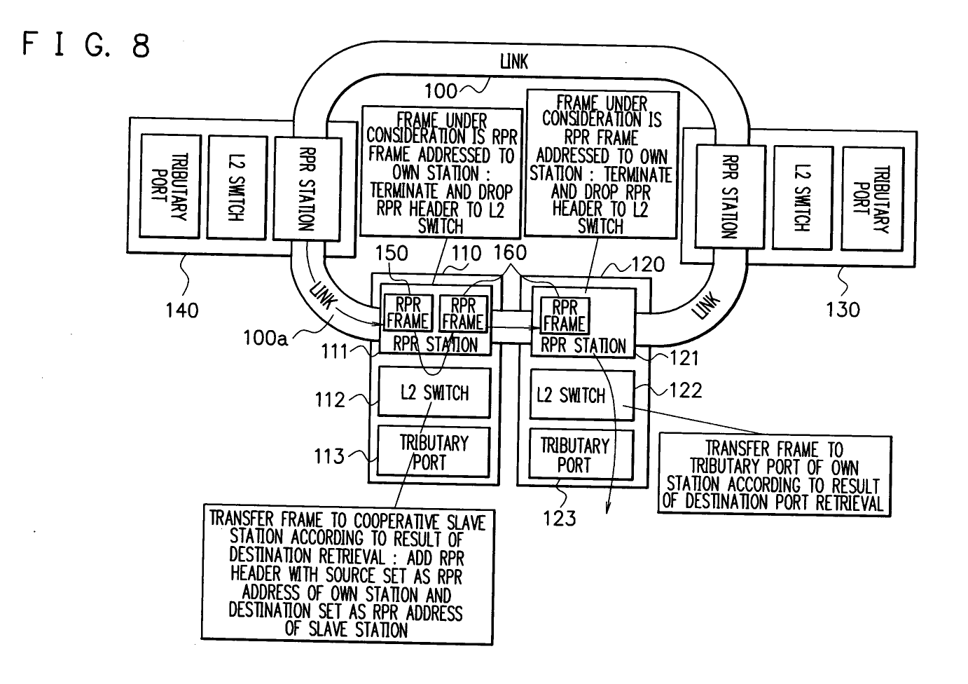

FIG. 8 shows operation in which the master station receives an RPR frame from a link on a side opposite to the slave station and outputs the frame as a MAC frame from a tributary port of the slave node device.

The master station 111 receives the RPR frame 150 transferred from a second node device 140 via the link 100a on the side of the master device 110. Since the RPR frame 150 is addressed to the station of the own module, the master station 111 terminates the RPR frame and drops the frame as a MAC frame to the L2 switch 112.

Next, the switch 112 calculates a destination tributary port of LAG according to an algorithm. The resultant port from the calculation is a tributary port 123 of the station of the slave node device 120, so that the master station 111 creates an RPR header, specifically, sets the source as the master station 111 and the destination as the slave station 121 and adds the header to the MAC frame to send the frame as an RPR frame 160 to a link on the slave station side.

The slave station 121 receives the RPR frame from the master station 111. Since the frame is addressed to the slave station 121, the station 121 terminates the RPR frame and drops a MAC frame to the L2 switch 122. The L2 switch 122 calculates according to the algorithm the tributary port 123 of the own station 121 as a destination port and sends the MAC frame from the tributary port 123.

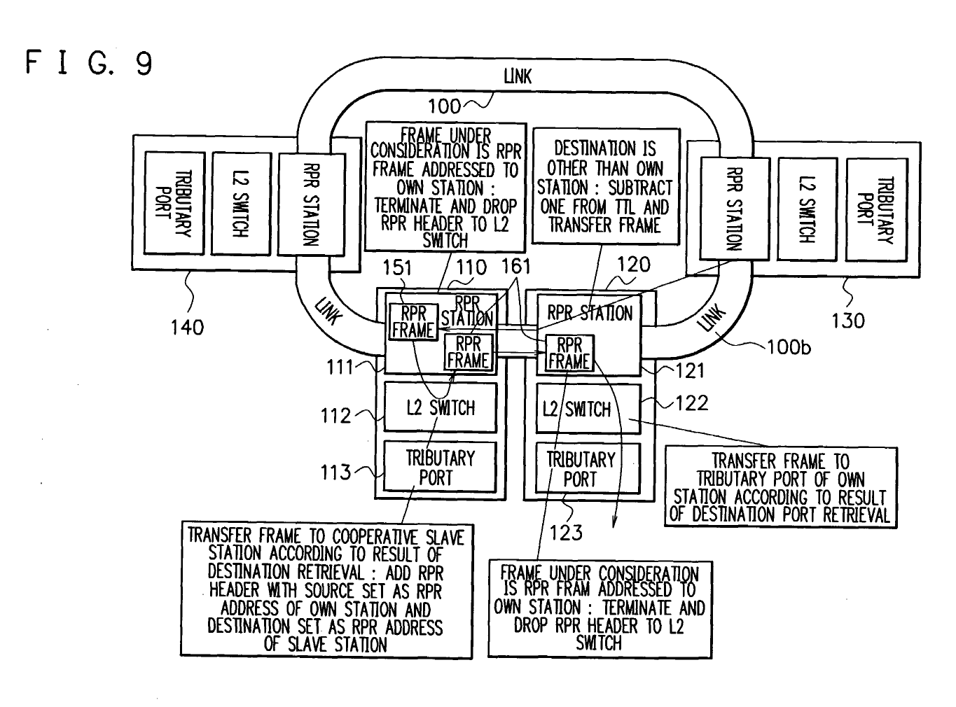

FIG. 9 shows operation in which a master station receives an RPR frame from a link on a slave station side and outputs the frame as a MAC frame from a tributary port belonging to the slave node device.

The slave station 121 once receives the RPR frame 151 transferred from the second RPR node device 130 via the link 100b on the side of the slave node device 120. The slave station 121 refers to the destination MAC address of the RPR frame and determines that the frame is addressed to other than the own station. Therefore, the slave station 121 subtracts one from the TTL update value to send the frame to a downstream link (toward the master node device 110).

The master station 111 refers to the destination MAC address of the received RPR frame to confirm that the frame is addressed to the own station, i.e., the master station 111. Then, the master station 111 terminates the RPR frame 151 and drops the frame as a MAC frame to the L2 switch 112.

The switch 112 conducts a calculation for a destination tributary port of LAG according to an algorithm. The resultant port from the calculation is the port 123 of the slave node device 120. Therefore, the master station 111 adds to the MAC frame an RPR header which sets the source as the master station 111 and the destination as the slave station 111 and then transfers the frame as an RPR frame 161 to a link on the side of the slave station 121.

The slave station 121 receives the RPR frame 161 from the master station 111. Since the destination of the received RPR frame is the own station, the slave station 121 terminates the RPR frame and drops the frame as a MAC frame to the L2 switch 122. The L2 switch 122 calculates according to the algorithm the tributary port 123 of the own station as a destination port and outputs the MAC frame from the tributary port 123.

FIG. 10 shows operation in which the master station transmits the MAC frame received from the tributary port of the master node device as an RPR frame to a link on a side opposite to the side of the slave station.

The master station 111 having received a MAC frame 170 from the tributary port 113 of the master node device 110 retrieves, based on the routing table in the L2 switch 112, an MAC address of an RPR station as the destination of the frame. The master station 111 also retrieves a path direction for the shortest path to the destination on the basis of the topology database in the L2 switch 112.

The master station 111 creates an RPR header with the source set as the own station and the destination set as the retrieved MAC address and then adds the header to the MAC frame to thereby produce an RPR frame 180. The master station 111 sends the RPR frame 180 to the link 100a on the master station side according to the retrieved path direction.

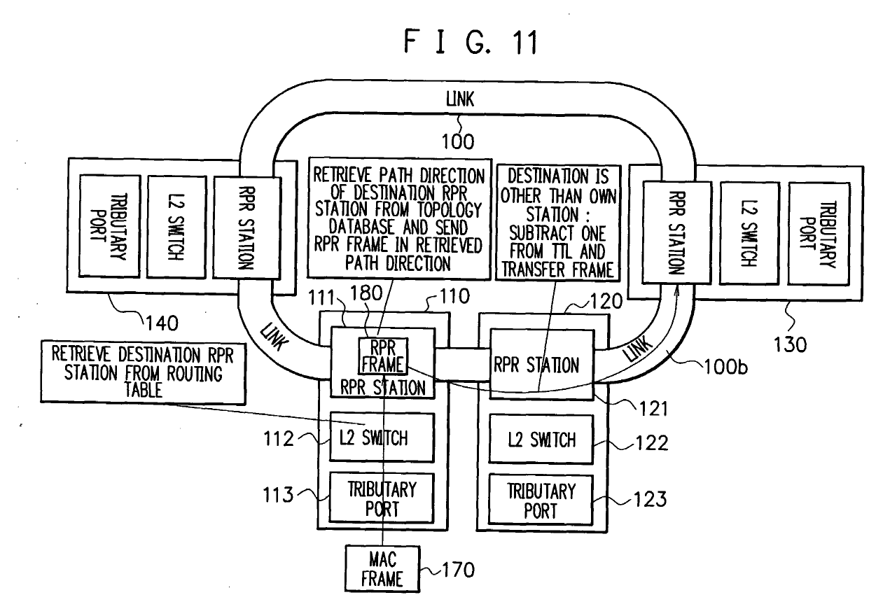

FIG. 11 shows operation in which the master station having received the MAC frame from the tributary port of the master node device outputs the frame as an RPR frame to a link on the slave station side.

The master station 111 having received the MAC frame 170 from the tributary port 113 of the master node device 110 retrieves, on the basis of the routing table in the L2 switch 112, a MAC address of an RPR station as the destination of the frame. The master station 111 also retrieves a path direction of the shortest path to the destination based on the topology database in the L2 switch 112.

The master station 111 generates an RPR header in which the source is set as the own station and the destination is set as the retrieved MAC address and adds the header to the MAC frame to produce an RPR frame 180. The master station 111 transmits the RPR frame 180 to the link 100b on the slave station side according to the retrieved path direction.

The slave station 121 receives the RPR frame 180 of which the destination is not the own station and accordingly subtracts one from the TTL update value to transfer the frame to the link 100b.

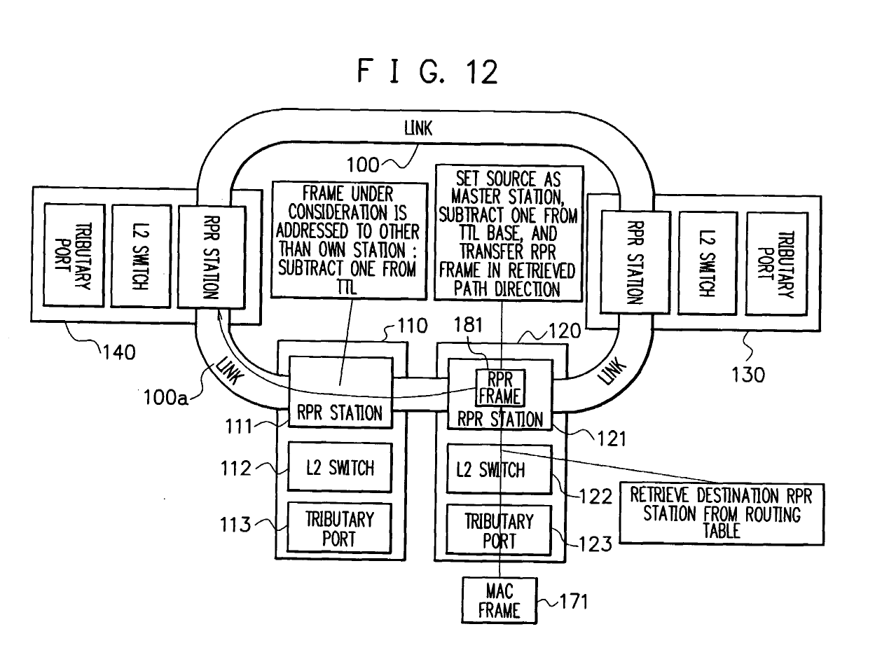

FIG. 12 shows operation in which the slave station receives a MAC frame from the tributary port of the slave node device and sends the frame as an RPR frame to a link on the master station side.

The slave station 121 having received a MAC frame 171 from the tributary port 123 of the slave node device 120 retrieves a MAC address of an RPR station as the destination of the frame on the basis of the routing table in the L2 switch 122. Also, the slave station 121 retrieves a path direction of the shortest route to the destination according to the topology database in the L2 switch 122.

The slave station 121 then creates an RPR header with the source set as the master station 111, the destination set as the retrieved MAC address, and the TTL base (the TTL initial value) decremented by one. The slave station 121 adds the RPR header to the MAC frame 171 to generate an RPR frame 181 and then outputs the RPR frame 181 to the link 100a on the master station side according to the retrieved path direction.

The master station 111 receives the RPR frame 181 sent from the slave station 121. The RPR address of the destination is other than the MAC address of the own station, i.e., the master station. Therefore, the master station 111 subtracts one from the TTL update value and transmits the RPR frame to the downstream link, i.e., the link 100a.

As describe above, the TTL base (the TTL initial value) can be regarded as the number of stations from the source to the destination. And the TTL update value reflects the decrement or decrease in the TTL value at transfer of the frame to the next station and can be hence regarded as the number of remaining stations to the destination. In the case of FIG. 12, by transmitting the frame 181 to the link 100a on the master station side, the number of stations to the destination is lowered by one. The TTL base (initial value) is decremented by one so that the frame actually sent from the slave station 121 is recognized as if the frame is sent from the master station 111. The TTL value (TTL update value) is decremented by one in a way similar to that of the ordinary operation to transfer an RPR frame in which the destination of the frame is other than the own station.

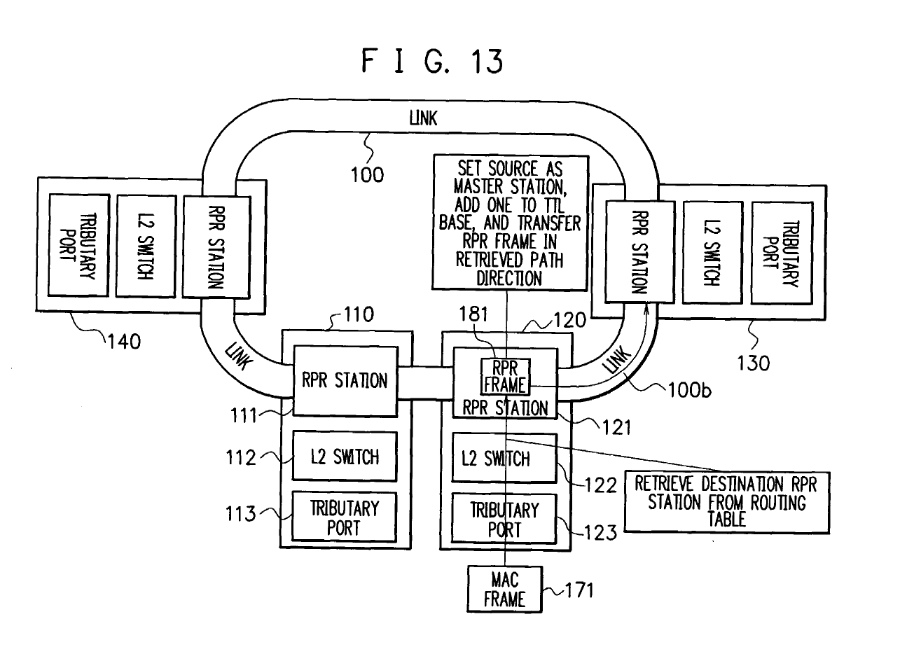

FIG. 13 shows operation in which the slave station having received a MAC frame from the tributary port of the slave node device sends the frame as an RPR frame to a link on the station of own device.

The slave station 121 receives the MAC frame 171 from the tributary port 123 of the slave node device 120 to retrieve a MAC address of an RPR station as the destination of the frame on the basis of the routing table in the L2 switch 122. The slave station 121 also retrieves a path direction of the shortest path to the destination based on the topology database in the switch 122.

The slave station 121 adds to the MAC frame an RPR header with the source set as the master station 111, the destination set as the retrieved MAC address, and the TTL base (the TTL initial value) incremented by one, to thereby create an RPR frame 181. The slave station 121 delivers the RPR frame 181 to the link 100b on the slave station side according to the retrieved path direction.

As described in conjunction with FIG. 12, the TTL base (the TTL initial value) can be regarded as the number of stations from the source to the destination. In the operation shown in FIG. 13, the TTL base is incremented by one for the following reason. The RPR frame 181 is delivered to the link 100b on the slave station side. However, the frame is actually sent from the slave station 121. In order that the frame seems to be transmitted from the master station 111 in the direction opposite to the output direction (the link 100b), it is required to add one to the number of stations to the destination.

The embodiment above leads to advantages as follows. First, since the RPR station and the tributary port are in a redundant configuration in accordance with the embodiment of the RPR network system, it is possible to protect the accommodated communication lines at occurrence of failure. Second, the RPR station in the redundant configuration is arranged as a separated station such that information required to control the providing of redundancy is communicated via a link between the stations, and hence the structure of the system can be simplified.

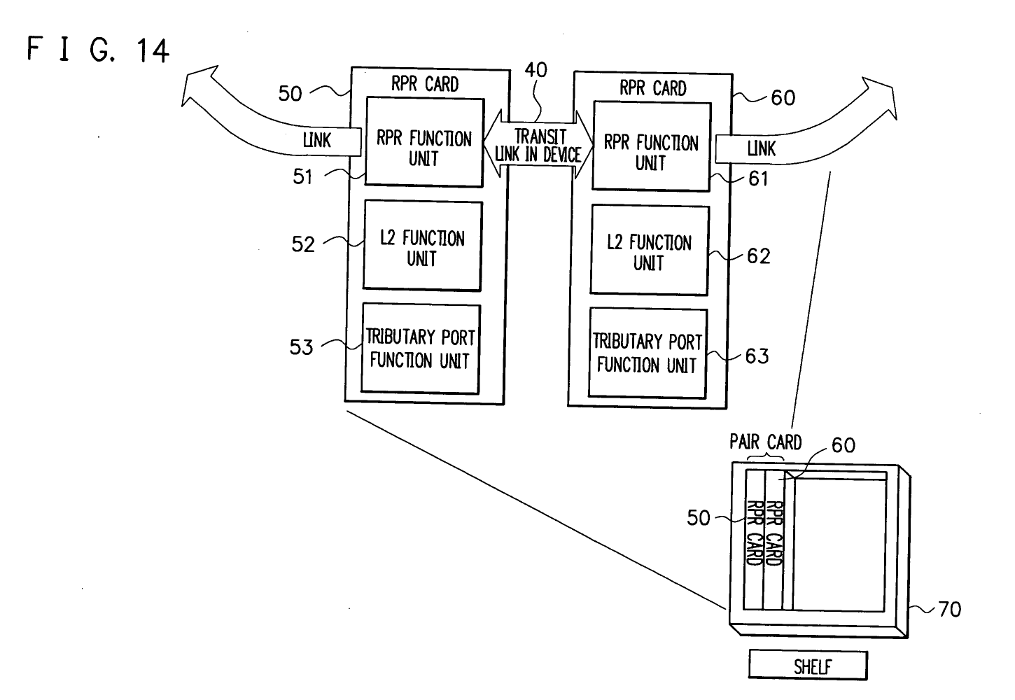

Description will now be given of a variation of the embodiment. Although the variation is similar in the basic configuration to the embodiment, the variation has a different point, i.e., structure to couple two adjacent RPR node devices with each other. In the variation, the two adjacent node devices, which conduct cooperative operation, are configured in a pair of cards to be mounted on one shelf as shown in FIG. 14.

In the configuration, RPR cards 50 and 60 are installed in a shelf 70 and are coupled with each other via a transit link 40 therein. The card 50 includes an RPR function unit 51, an L2 function unit 52, and a tributary port function unit 53. The configuration is almost equal to that shown in FIG. 4. Similarly, the card 60 includes an RPR function unit 61, an L2 function unit 62, and a tributary port function unit 63.

The transit link 40 is a high-speed transmission path using a backboard of the shelf 70 and is capable of easily securing the bandwidth more than the RPR ring capacity.

The variation is constructed in a redundant configuration for the RPR function unit and the tributary port. This leads to an advantage in which the accommodated communication lines are protected at occurrence of failure and in-service maintenance can be conducted.

The embodiment is only a favorable embodiment in accordance with the present invention. However, the present invention is not restricted by the embodiment. The embodiment may be changed and modified in various ways to construct various configurations by those skilled in the art.

That is, the embodiment of the RPR network system conducts operations through processing, modules, and functions implemented by a computer on the basis of program instructions. The program sends instructions to the constituent components of the computer to achieve the predetermined processing and functions. For example, the CPU 11 resultantly executes the RPR layer signal processing in the RPR function unit 12 and the ethernet layer signal processing in the L2 function unit. The processing and modules are realized by specific units or modules implemented through cooperation of the program and the computer.

The object of the present invention is also achieved as follows. There is prepared a computer-readable recording medium, i.e., a storage medium having stored a software program code realizing the functions of the embodiment. The computer such as a CPU or a Micro Processing Unit (MPU) of the RPR node device reads from the medium the program code and executes the program code. Additionally, the object of the present invention is also achievable by loading the program code via a communication line directly in a computer, which thereafter executes the program code.

In this situation, the program code obtained from the storage medium or loaded from the communication line is executed to implement the functions of the embodiment. The storage medium having recorded the program code is also included in the scope of the present invention.

The storage medium to provide the program code to the system includes, for example, a floppy disk, a hard disk, an optical disk, a magnetooptical disk, a Compact Disk-Read Only Memory (CD-ROM), a CD-R, a nonvolatile memory card, an ROM, and a magnetic tape.

As described above, in the embodiment of the present invention, the two adjacent RPR node devices operate in a cooperative fashion to configure one virtual RPR node device. In the virtual RPR node device, the RPR station of the node device as a master device conducts communication with other node devices on the link. Also, a Link Aggression Group (LAG) is constructed between ports of the two cooperative node devices so that the ports of the node devices are adopted as ports of the virtual node device. At occurrence of failure in the slave device, the RPR station and the port on the master device side are employed to continue communication. On the other hand, if failure occurs in the master device, a switching operation is conducted such that the RPR node device operating as the slave module up to this point replaces the master module and continuously conducts communication using the RPR station and the port which operate as units of the slave module up to this point.

Thanks to the redundant configuration, in a relationship of the virtual RPR node device with the other RPR node devices on the link, the configuration implements the function of one virtual RPR node device. In a relationship in the virtual RPR node device, the configuration implements a function to provide mutually independent RPR node devices. By setting the master module to be changed over and by forming a Link Aggression Group (LAG) of the ports of the respective node devices, the RPR function and the ethernet (registered trademark) port function are prepared in a redundant configuration at the same time. Therefore, even if failure occurs, the communication with other RPR node devices can be continuously accomplished. Specifically, the MAC frame can be continuously communicated without separating the associated port from the RPR ring.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A Resilient Packet Ring (RPR) network system including a plurality of node devices connected on a link to each other in which two adjacent RPR node devices selected from the plural node devices cooperatively operate to configure one virtual RPR node device, wherein:
the two adjacent RPR node devices are set such that a first one thereof is a master device for communicating as the virtual RPR node device with a particular one of the RPR node devices and a second one thereof is a slave device not communicating as the virtual RPR node device with the particular RPR node device,
the master and slave devices being replaceable by each other,
either one of ports belonging to the master and slave devices being capable of outputting data therefrom.

2. The RPR network system in accordance with claim 1, wherein:
each of the two adjacent RPR node devices includes a control unit, an RPR function unit, and an L2 function unit;
the control units of the two node RPR devices mutually notify states of failure in the respective node devices, Media Access Control (MAC) addresses of the respective node devices, and states of ports respectively belonging to the respective node devices to each other to thereby share the information items regarding the virtual RPR node device, and change over the setting of the master device on the basis of the states of failure shared therebetween;
the RPR function units control a communication function on an RPR layer, transmit data from the master device to the particular RPR node device designating the MAC address of the master device as a source address, and receive by the master device from the particular RPR node device data designating the MAC address as a destination address; and
the L2 function units select one of the ports which are under control of the virtual RPR node device and which belong respectively to the master and slave devices to assign the port as a destination port.

3. The RPR network system in accordance with claim 1, wherein:
each of the two adjacent RPR node devices respectively includes information sharing units, master device switching units, RPR function control units and, and port assigning units;
the information sharing units mutually notify states of failure in the respective node devices, MAC addresses of the respective node devices, and states of ports respectively belonging to the respective node devices to each other to thereby share the information items regarding the virtual RPR node device;
the master module switching units change over the setting of the master device on the basis of the states of failure shared therebetween;
the RPR function control units control means control a communication function on an RPR layer, transmit data from the master device to the particular RPR node device designating the MAC address of the master device as a source address, and receive by the master device from the particular RPR node device data designating the MAC address as a destination address; and
the port assigning units select one of the ports which are under control of the virtual RPR node device and which belong respectively to the master and slave devices to assign the port as a destination port.

4. The RPR network system in accordance with claim 2, wherein the RPR function units output therefrom an RPR frame obtained by adding an RPR header with the source set as a MAC address of a communicating device to a MAC frame.

5. The RPR network system in accordance with claim 4, wherein when receiving data from the particular RPR node device by the master device, if the destination port assigned by the L2 function units is a port belonging to the slave device, the RPR function units add an RPR header with the source set as the master device and the destination set as the slave device to a MAC frame and send the MAC frame to the slave device.

6. The RPR network system in accordance with claim 4, wherein when transmitting data to the particular RPR node device, if a MAC frame is received from a port belonging to the slave device, the RPR function units add an RPR header with the source set as the master device and the destination set as the particular RPR node device to the MAC frame and send the MAC frame to the particular RPR node device.

7. The RPR network system in accordance with claim 6, wherein when transmitting data to the particular RPR node device, if a MAC frame is received from a port belonging to the slave device, the RPR function units correct an initial value and an update value of a Time To Live (TTL) of the RPR header to be substantially equal to the initial value and the update value of TTL obtained when the frame is transmitted from the master device.

8. The RPR network system in accordance with claim 2, wherein the L2 function units conduct the assigning of the destination being shared between the master device and the slave device.

9. An RPR node device for use with a RPR network system including a plurality of node devices connected on a link to each other in which two adjacent RPR node devices selected from the plural node devices cooperatively operate to configure one virtual RPR node device, the RPR node device being used for the two adjacent RPR node devices wherein:
the two adjacent RPR node devices are set such that a first one thereof is a master device for communicating as a representative of the virtual RPR node device with a particular one of the RPR node devices and a second one thereof is a slave device not communicating as the representative of the virtual RPR node device with the particular RPR node device,
the master and slave devices being replaceable by each other;
each of the two adjacent RPR node devices includes a control unit, an RPR function unit, and an L2 function unit;
the control units of the two node RPR devices mutually notify states of failure in the respective node devices, MAC addresses of the respective node devices, and states of ports respectively belonging to the respective node devices to each other to thereby share the information items regarding the virtual RPR node device, and change over the setting of the master device on the basis of the states of failure shared therebetween;
the RPR function units control a communication function on an RPR layer, transmit data from the master device to the particular RPR node device designating the MAC address of the master device as a source address, and receive by the master device from the particular RPR node device data designating the MAC address as a destination address; and
the L2 function units select one of the ports which are under control of the virtual RPR node device and which belong respectively to the master and slave devices to assign the port as a destination port.

10. An RPR node device for use with a RPR network system including a plurality of node devices connected on a link to each other in which two adjacent RPR node devices selected from the plural node devices cooperatively operate to configure one virtual RPR node device, the RPR node device being used for the two adjacent RPR node devices wherein:
the two adjacent RPR node devices are set such that a first one thereof is a master device for communicating as a representative of the virtual RPR node device with a particular one of the RPR node devices and a second one thereof is a slave device not communicating as the representative of the virtual RPR node device with the particular RPR node device,
the master and slave devices being replaceable by each other;
each of the two adjacent RPR node devices respectively includes information sharing units, master device switching units, RPR function control units, and port assigning units;
the information sharing units mutually notify states of failure in the respective node devices, MAC addresses of the respective node devices, and states of ports respectively belonging to the respective node devices to each other to thereby share the information items regarding the virtual RPR node device;
the master device switching units change over the setting of the master device on the basis of the states of failure shared therebetween;
the RPR function control units control a communication function on an RPR layer, transmit data from the master device to the particular RPR node device designating the MAC address of the master device as a source address, and receive by the master device from the particular RPR node device data designating the MAC address as a destination address; and
the port assigning units select one of the ports which are under control of the virtual RPR node device and which belong respectively to the master and slave devices to assign the port as a destination port.

11. The RPR node device in accordance with claim 9, wherein the RPR function units output therefrom an RPR frame obtained by adding an RPR header with the source set as a MAC address of a communicating device to a MAC frame.

12. The RPR node device in accordance with claim 11, wherein when receiving data from the particular RPR node device by the master device, if the destination port assigned by the L2 function units is a port belonging to the slave device, the RPR function units add an RPR header with the source set as the master device and the destination set as the slave device to a MAC frame and send the MAC frame to the slave device.

13. The RPR node device in accordance with claim 11, wherein when transmitting data to the particular RPR node device, if a MAC frame is received from a port belonging to the slave device, the RPR function units add an RPR header with the source set as the master device and the destination set as the particular RPR node device to the MAC frame and send the MAC frame to the particular RPR node device.

14. The RPR node device in accordance with claim 13, wherein when transmitting data to the particular RPR node device, if a MAC frame is received from a port belonging to the slave device, the RPR function units correct an initial value and an update value of a Time To Live (TTL) of the RPR header to be substantially equal to the initial value and the update value of TTL obtained when the frame is transmitted from the master device.

15. The RPR node device in accordance with claim 9, wherein the L2 function units conduct the assigning of the destination being shared between the master device and the slave device.

16. A redundancy method for an RPR node device for use with a RPR network system including a plurality of node devices connected on a link to each other in which two adjacent RPR node devices selected from the plural node devices cooperatively operate to configure one virtual RPR node device, the RPR node device being used for the two adjacent RPR node devices wherein:
the two adjacent RPR node devices are set such that a first one thereof is a master device for communicating as a representative of the virtual RPR node device with a particular one of the RPR node devices and a second one thereof is a slave device not communicating as the representative of the virtual RPR node device with the particular RPR node device,
the master and slave devices being replaceable by each other; and
each of the two adjacent RPR node devices includes a control unit, an RPR function unit, and an L2 function unit, the method comprising the steps of:
mutually notifying, by the control units of the two node RPR devices, states of failure in the respective node devices, MAC addresses of the respective node devices, and states of ports respectively belonging to the respective node devices to each other to thereby share the information items regarding the virtual RPR node device, and change over the setting of the master device on the basis of the states of failure shared therebetween;
controlling by the RPR function sections a communication function on an RPR layer, transmitting data from the master device to the particular RPR node device designating the MAC address of the master device as a source address, and receiving by the master device from the particular RPR node device data designating the MAC address as a destination address; and
selecting by the L2 function units one of the ports which are under control of the virtual RPR node device and which belong respectively to the master and slave devices to assign the port as a destination port.

17. The redundancy method for an RPR node device in accordance with claim 16, wherein the RPR function units output therefrom an RPR frame obtained by adding an RPR header with the source set as a MAC address of a communicating device to a MAC frame.

18. The redundancy method for an RPR node device in accordance with claim 17, wherein when receiving data from the particular RPR node device by the master device, if the destination port assigned by the L2 function units is a port belonging to the slave device, the RPR function units add an RPR header with the source set as the master device and the destination set as the slave device to a MAC frame and send the MAC frame to the slave module.

19. The redundancy method for an RPR node device in accordance with claim 17, wherein when transmitting data to the particular RPR node device, if a MAC frame is received from a port belonging to the slave device, the RPR function units add an RPR header with the source set as the master device and the destination set as the particular RPR node device to the MAC frame and send the MAC frame to the particular RPR node device.

20. The redundancy method for an RPR node device in accordance with claim 19, wherein when transmitting data to the particular RPR node device, if a MAC frame is received from a port belonging to the slave device, the RPR function units correct an initial value and an update value of a Time To Live (TTL) of the RPR header to be substantially equal to the initial value and the update value of TTL obtained when the frame is transmitted from the master device.

21. The redundancy method for an RPR node device in accordance with claim 16, wherein the L2 function units conduct the assigning of the destination being shared between the master device and the slave device.

22. A program causing a computer to perform the redundancy method for an RPR node device in accordance with claim 16.

23. A computer-readable medium storing therein the program in accordance with claim 22.
